(19) United States
(12) Patent Application Publication
(10) Pub. No.: US 2007/0295709 A1
(43) Pub. Date: Dec. 27, 2007

(54) Ceramic heating elements

(75) Inventor: Craig A. Willkens, Sterling, MA (US)

Correspondence Address: EDWARDS ANGELL PALMER & DODGE LLP, P.O. BOX 55874, BOSTON, MA, 02205, US

(73) Assignee: Saint-Gobain Ceramics & Plastics, Inc., Worcester, MA (US)

(21) Appl. No.: 11/801,683

(22) Filed: May 9, 2007

Related U.S. Application Data
(60) Provisional application No. 60/799,218, filed on May 9, 2006.

(51) Int. Cl. H05B 7/00; F23Q 7/00; H05B 7/16; H05B 1/00

(52) U.S. Cl. 219/268; 219/200; 219/260; 219/270

(57) ABSTRACT

In one aspect, ceramic resistive heating elements are provided that comprise three or more electrically segregated conductive zones. In another aspect, ceramic heating elements are provided that comprise a plurality of conductive zones, wherein only a portion of the conductive zones pass current during use of the heating element. In a further aspect, heating elements of the invention can be readily modified to operate at a variety of voltages. The multiple conductive zones can provide extended heating element operating lifetimes.

The present application clams the benefit of U.S. provisional application No. 60/799,218 filed May 9, 2006, which is incorporated by reference herein in its entirety.

### BACKGROUND

1. Field of the Invention

In one aspect, the invention provides new ceramic resistive heating elements that comprise multiple conductive zones, particularly three or more conductive zones or pathways. In another aspect, ceramic heating elements are provided that comprise a plurality of conductive zones, wherein only a portion of the conductive zones pass current during use of the heating element. Preferred heating elements of the invention also can be readily modified to operate at a variety of voltages.

2. Background

Ceramic materials have enjoyed great success as igniters in e.g. gas-fired furnaces, stoves and clothes dryers. Ceramic igniter production includes constructing an electrical circuit through a ceramic component a portion of which is highly resistive and rises in temperature when electrified by a wire lead. See, for instance, U.S. Pat. Nos. 6,028,292; 5,801,361; 5,405,237; and 5,191,508.

Typical igniters have been generally hair pin-shaped elements with a highly resistive “hot zone” at the igniter tip with one or more conductive “cold zones” providing to the hot zone from the opposing igniter end. One currently available igniter, the Mini-Igniter™, available from Norton Igniter Products of Milford, N.H., is designed for 12 volt through 120 volt applications and has a composition comprising aluminum nitride (“AlN”), molybdenum disilicide (“MoSi₂”), and silicon carbide (“SiC”).

A variety of performance properties are required of ceramic igniter systems, including high speed or fast time-to-temperature (i.e. time to heat from room temperature to design temperature for ignition) and sufficient robustness to operate for extended periods without replacement. Many conventional igniters, however, do not consistently meet such requirements. For instance, current ceramic igniters also have suffered from electrical failure during use.

It thus would be desirable to have new heating elements.

### SUMMARY OF THE INVENTION

We now provide ceramic heating elements that include new configurations of regions of differing resistivity. Preferred heating elements of the invention are capable of increased operating lifetimes and robustness. Heating elements of the invention are useful for a variety of applications, including as ignition elements for dry and wet fuels.

More particularly, in one aspect, new ceramic resistive heating elements are provided that comprise three or more conductive zones. Preferred heating elements of the invention will have a greater number of conductive zones. In preferred systems, the multiple conductive pathways can function as a plurality of conductive wires extending through the heating element.

In another aspect, ceramic heating elements are provided that comprise a plurality of conductive zones, wherein only a portion of the conductive zones pass current during use of the heating element.

In a yet further aspect, ceramic heating elements are provided that comprise a plurality of conductive zones, wherein two or more of the conductive pathways have differing temperature coefficients of resistance.

In particular, one or more of the conductive pathways may have a positive temperature coefficient of resistance (PTCR) and one or more of the conductive pathways may have a negative temperature coefficient of resistance (NTCR). Thus, for instance, conductive pathways of differing temperature coefficients of resistance may be blended in a single heating element to provide desired heating performance.

Hence, by such designs, performance properties of the heating element may be selectively provided, e.g. the PTCR conductive pathways can enable fast time-to-ignition temperature characteristics of a heating element while the NTCR conductive pathways can enable operation of the heating element over an extended voltage range, including at high voltages such as in excess of 100 or 200 volts.

Heating elements of the invention can exhibit enhanced operating lifetimes as the plurality of conductive pathways or zones provide for redundancy in the element, i.e. if a single conductive pathway of the element fails, other conductive pathways can continue to provide a complete circuit through the heating element.

In particular, current ceramic heating elements may fail due to oxidative aging or other degradation of a conductive pathway of the heating element. In systems of one o more of the multiple conductive pathways may compensate for any failed conductive zone.

Thus, in certain preferred designs, electrical leads (supplying power to a heating element) can be shifted, e.g. by twisting of an electrical lead housing communicating with a heating element, to thereby engage alternate conductive pathways as may needed for optimal functioning of the heating element.

In another aspect, heating elements are provided that can be readily modulated to operate effectively at a variety of voltages, including e.g. 6, 8, 10, 12, 24, 120, 220, 230 or 240 volts.

In this aspect, a selected area of the heating element proximal end can be in communication with a power source (e.g., electrical lead). The proximal end area selected will engage a corresponding area of conductive pathways through the heating element and thereby provide the desired operating voltage.

Heating elements of the invention can be fabricated by a variety of approaches.

For example, in one preferred method, materials of differing resistivies may be formed into desired configurations e.g. rod-shaped elements and those shaped elements can be bundled and compacted such as through an extrusion process to provide a heating element having a plurality of conductive pathways. That is, three or more of the conductive rod elements can be segregated through bundling together with interposing insulator rod elements and the associated rod elements then reduced in cross-section dimension such as through extrusion to provide an integral heating element. A resistive wire or other resistive element (such as a resistive ceramic zone) can be bundled with the conductive and insulator elements in electrical communication with the conductive zones.

A co-axial heating element design also may be preferred for at least some applications e.g. where the element contains an inner region that comprises a plurality of conductive pathways which deliver power to a distal resistive (ignition) zone where current flows through to an outer element region that comprises conductive pathways.

A preferred fabrication process may include a micro-replication sequence. Photolithography also may be employed to sequentially build the multiple-conductive path ceramic structure.

In one aspect, preferred heating elements of the invention of the invention have a rounded cross-sectional shape along at least a portion of the heating element length (e.g., the length extending from where an electrical lead is affixed to the heating element to a resistive hot zone). More particularly, preferred heating elements may have a substantially oval, circular or other rounded cross-sectional shape for at least a portion of the heating element length, e.g. at least about 10 percent, 40 percent, 60 percent, 80 percent, 90 percent of the heating element length, or the entire heating element length. A substantially circular cross-sectional shape that provides a rod-shaped heating element is particularly preferred.

The invention also provides heating elements that have non-rounded or non-circular cross-sectional shapes for at least a portion of the heating element length.

Heating elements of the invention also may include additional functions such as a thermocouple circuit which may operate as a flame sensor or flame rectifier.

Ceramic heating of the invention can be employed at a wide variety of nominal voltages, including nominal voltages of 6, 8, 10, 12, 24, 120, 220, 230 and 240 volts.

Heating elements of the invention are useful for ignition in a variety of devices and heating systems. More particularly, heating systems are provided that comprise a sintered ceramic heating element as described herein. Specific heating systems include gas cooking units, heating units for commercial and residential buildings. Heating elements of the invention also may be useful as glow plugs e.g. for use in a combustion engine.

As referred to herein, the term positive temperature coefficient of resistance (or “PTCR”) indicates the material in question (e.g. conductive pathway of a heating element) has a decreased resistance at elevated temperatures, e.g. where at 25° C. the resistance of the material in question (again e.g. conductive pathway of a heating element) is suitably less than about 0.5 times, preferably less than about 0.2 times the resistance of the material in question (conductive pathway) at operational temperature of the device particularly ignition temperature of the heating element, which may be e.g. 700° C., 800° C., 900° C., 1000° C., 1100° C., 1200° C., or 1300° C. or more, depending on the particular design and application of the heating element.

As referred to herein, the term negative temperature coefficient of resistance (or “NTCR”) indicates the material in question (e.g. conductive pathway of a heating element) has an increased resistance at elevated temperature, e.g. where the stance of the material in question (again e.g. conductive pathway of a heating element) at 25° C. is suitably at least 2 times, preferably at least about 5 times the resistance of the material in question (conductive pathway) at operational temperature of the device particularly ignition temperature of the heating element, which may be e.g. 700° C., 800° C., 900° C., 1000° C., 1100° C., 1200° C., or 1300° C. or more, depending on the particular design and application of the heating element.

Other aspects of the invention are disclosed infra.

### BRIEF DESCRIPTION OF THE DRAWINGS

FIG. 1 shows a preferred heating element system of the invention in phantom view;

FIG. 2 shows another preferred heating element of the invention in phantom view;

FIGS. 3A and 3B illustrate processing stages to provide a preferred heating element of the invention;

FIG. 4. shows a further preferred heating element of the invention in cut-away view; and

FIG. 5 shows a further preferred heating element of the invention having a co-axial configuration.

### DETAILED DESCRIPTION OF THE INVENTION

As discussed above, new ceramic heating element systems are provided that include a plurality of conductive regions, particularly three or more conductive zones. Heating elements of the invention are particularly useful as resistive ignition elements (igniters) for dry and wet fuels.

In another aspect, ceramic heating elements are provided that comprise a plurality of conductive zones, wherein only a portion of the conductive zones pass current during use of the heating element.

In yet further aspects, ceramic heating elements are provided that comprise a plurality of conductive zones, wherein two or more of the conductive pathways have differing temperature coefficients of resistance. In particular, one or more of the conductive pathways may have a positive temperature coefficient of resistance (PTCR) and one or more of the conductive pathways may have a negative temperature coefficient of resistance (NTCR).

In general, conductive zones of heating elements of the invention will exhibit decreased resistance in a desired direction and thereby provide a conductive pathway through a heating element.

In preferred designs, the multiple conductive pathways may be of small cross-sectional dimension and can be viewed as ceramic wires extending through a heating element, such as through the heating element length to provide multiple conductive pathways. In use, current can flow through multiple ceramic wires to a resistive zone of the heating element that can reach fuel ignition temperatures.

As also discussed above, in a further aspect, heating elements are provided having a plurality of conductive zones or ceramic wires, and a selected area of the heating element proximal end can be in communication with a power source such as one or more electrical leads. The proximal end area selected will engage a corresponding area of conductive pathways through the heating element and thereby provide the desired operating voltage.

Thus, in this aspect, a single produced heating element can be effectively operated at a wide range of distinct voltages simply through use of distinct electrical leads.

The invention thus includes methods to provide power (e.g. current) to a heating element, which include providing a resistive ceramic heating element comprising at least three electrically segregated conductive zones; and engaging one or more electrical connections with respect to the heating element to provide power to one or more selected conductive zones. The one or more electrical connections may engage a selected number of conductive zones whereby the igniter operates at a targeted voltage. As discussed above, the one or more electrical connections also may be shifted during operational lifetime of the heating element to provide power to one or more alternate conductive zones, i.e. to provide power to one or more conductive zones that did not pass current prior to shifting of the one or more electrical connections.

Referring now to the drawings, FIG. I shows a preferred heating element 10 in partial phantom view where plurality of conductive regions or ceramic wires 12 are electrically segregated through interposed insulator regions 14. Heating element 10 further includes conductive cap element 16 which permits a complete circuit through the heating element as well as resistive region 18 which suitably may be a resistive wire embedded within the heating element distal portions and in electrical connection with conductive regions 12, as generally shown in FIG. 2. Rather than an implanted resistive wire, resistive region 18 can be provided by other approaches, including a resistive ceramic region. It also should be appreciated that cap element 16 can provide resistive heating, particularly if it is desired for the heating element to have tip heating i.e. heating to fuel ignition temperature (e.g. 800° C. to 1400° C.) localized around an end portion of the element.

The heating element electrical path also can be clearly seen in FIG. 2 where electrical power enters the heating element system 10 through the heating element proximal end 10a. Proximal ends 12a of conductive regions 12 may be affixed such as through brazing to an electrical lead (not shown) that supplies power to the heating element during use.

The operating voltage or resistance of heating element 10 can be established as desired by selection of the cross-sectional area (illustrated as 12b in FIG. 2) of conductive regions 12. Thus, the greater conductive cross-sectional area 12b of a heating element, the greater operating voltage or resistance the heating element may exhibit.

The heating element proximal end 10a suitably may be mounted within a variety of fixtures, such as where a ceramoplastic sealant material encases conductive element proximal end 12a as disclosed in U.S. Pat. No. 6,933,471.

As discussed above, in certain preferred designs, electrical leads that supply power to a heating element can be shifted, e.g. by twisting of lead housing communicating with a heating element, to thereby engage alternate conductive pathways as may needed for optimal functioning of the heating element. For instance, if one or more conductive pathways fail, the lead housing may be shifted to thereby engage and supply current through alternate, operational conductive pathways of the heating element.

In a certain preferred heating element system of the invention, the formed heating element may be configured to have a diameter (dimension a in FIG. 2) of 0.254 cm; a cross-sectional area (area in that same dimension) of 0.506 cm2; and a length (dimension b in FIG. 2) of 3 cm. The plurality of conductive regions or ceramic wires may have a cross-section dimension of about 10 μm each (dimension 12b in FIG. 2).

In preferred designs, the heating element may have in excess of 1,000, 2,000 or 3,000 conductive regions or ceramic wires. In one exemplary preferred design, the heating element contains 3225 ceramic conductive wires (which constitutes about 5 percent of the total heating element cross-sectional area) and where 161 of those 3225 regions pass current during heating element use. In one design, such a heating element may have a total resistance of 47.38 ohms, wherein a single conductive pathway has a diameter of 10 microns and a resistivity of 0.001 ohm-cm. In another system, such a heating element may have a total resistance of 142.16 ohms, wherein a single conductive pathway has a diameter of 10 microns and a resistivity of 0.003 ohm-cm. In such exemplary designs, the heating element may have a length of 3 cm and a diameter of 0.254 cm.

In heating elements of the invention that comprise a mixture of conductive zones of differing temperature coefficients of resistance, PTCR conductive zones and NTCR conductive zones available to pass current will be present in sufficient amounts to provide a desired effect, e.g. a sufficient number of PTCR conductive pathways to provide a fast time-to-temperature value such as less than 5, 4, 3 or 2 seconds and/or a sufficient number of NTCR conductive pathways to enable reliable operation at high voltages such as voltages in excess of 100 or 200 volts. In such heating elements that comprise a blend of PTCR and NTCR conductive pathways, suitably at least 5 or 10 percent of total conductive pathways available to pass current will be PTCR or NTCR, more typically at least about 15, 20 or 25 percent of total conductive pathways available to pass current will be PTCR or NTCR.

As referred to herein, the term “time-to-temperature” or similar term refers to the time for a heating element hot zone to rise from room temperature (ca. 25° C.) to a fuel (e.g. gas) ignition temperature of about 1000° C. A time-to-temperature value for a particular heating element is suitably determined using a two-color infrared pyrometer.

It should be appreciated that a wide variety of configurations may be suitable. For instance, ceramic conductive wires may suitably have a cross-section dimension of from about 0.1 μm to about 1,000 μm each, more preferably from about 1 μm to about 500 μm each, still more preferably from about 1 μm to about 5, 10, 20, 50 or 100 μm each. For many applications, it may be preferred that a ceramic wire has a cross-section dimension of at least about 5 μm or 10 μm.

Ceramic wires also may occupy a variety of cross-sectional areas of a heating element. For instance, the plurality of ceramic wires available to pass current suitably may occupy from about 0.001 percent to about 20 percent of the total heating element cross-sectional area, more typically from about 0.01, 0.1 or 0.5 percent to about 15 percent of the total heating element cross-sectional area, still more typically from about 1 to 5, 10 or 15 percent of the total heating element cross-sectional area. For many applications, it may be preferred that at least about 0.1 or 1 percent of the total heating element cross section area is comprised of a plurality of conductive ceramic wires.

As discussed, a heating element may in preferred designs suitably have a varying number of distinct (electrically segregated) conductive ceramic wires or pathways. In one aspect, a heating element has three or more discrete (electrically segregated) conductive ceramic pathways or wires. In certain preferred aspects, a heating element can have a relatively high number of discrete conductive ceramic pathways or wires, e.g. at least 50, 100, 200, 300, 400, 500, 700, 1000, 2000, 3000, 4000 or even 5000 or more discrete conductive ceramic pathways or wires. For certain preferred embodiments, a ceramic heating element will comprise at least 4, 5, 10, 20, 30 or 40 discrete conductive ceramic pathways or wires. As discussed above, in use of a heating element, only a portion of the total number of conductive ceramic pathways or wires may pass current, e.g. up to about 1, 2, 5, 10, 20, 30, 40, 50, 60, 70, 80, or 90 percent of total available discrete conductive ceramic pathways or wires of a heating element may suitably pass current during use of the heating element, wherein the balance of available conductive pathways or wires do not pass current during use. In general, heating elements with higher number of available conductive ceramic pathways or wires may utilize a relatively lower percentage of pathways during use of the heating element.

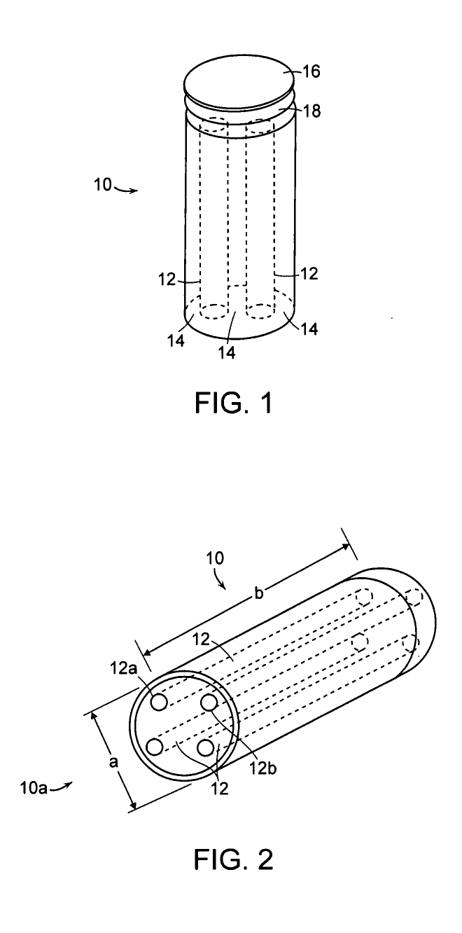

As discussed above, and exemplified in FIGS. 1 and 2, preferably, at least a substantial portion of the heating element length has a rounded cross-sectional shape along at least a portion of the heating element length, such as length a shown in FIG. 2. FIGS. 1 and 2 depict a particularly preferred configuration where heating element 10 has a substantially circular cross-sectional shape for about the entire length of the heating element to provide a rod-shaped heating element. However, as discussed above, preferred systems also include those where only a portion of the heating element has a rounded cross-sectional shape, such as where up to about 10, 20, 30, 40, 50, 60, 70 80 or 90 percent of the heating element length (as exemplified by heating element length a in FIG. 2) has a rounded cross-sectional shape; in such designs, the balance of the heating element length may have a profile with exterior edges. For instance, suitable heating element designs may comprise cooling fins or configurations to enhance ignition.

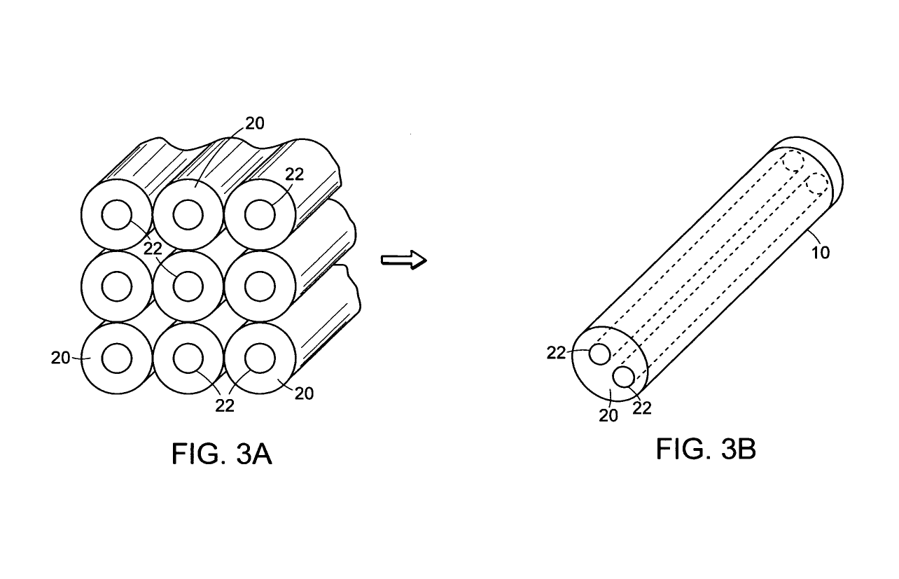

FIGS. 3A and 3B illustrate processing stages to provide a preferred heating element of the invention. Thus, in FIG. 3A rod shaped ceramic conductive elements or wires 20 are bundled together with interposing insulator rod elements 22. The elements 20 and 22 as generally depicted in FIG. 3A can be bundled and compacted such as through an extrusion process to provide a heating element having a plurality of conductive pathways as shown in FIG. 3B. A resistive wire or other resistive element (such as a resistive ceramic zone) can be bundled with the conductive and insulator elements in electrical communication with the conductive zones.

Extrusion of the heating elements may be suitably conducted by forming a fluid formulation of a ceramic composition and advancing the ceramic formulation through a die element that provides the heating element of desired configuration.

For instance, a slurry or paste-like composition of ceramic powders may be prepared, such as a paste provided by admixing one or more ceramic powders with an aqueous solution or an aqueous solution that contains one or more miscible organic solvents such as alcohols and the like. A preferred ceramic slurry composition for extrusion may be prepared by admixing one or more ceramic powders such as MoSi₂, SiC, silicon nitride, SiAlON, Al₂O₃, and/or AlN in a fluid composition of water optionally together with one or more organic solvents such as one or more aqueous-miscible organic solvents such as a cellulose ether solvent, an alcohol, and the like. The ceramic slurry also may contain other materials e.g. one or more organic plasticizer compounds optionally together with one or more polymeric binders.

A wide variety of shape-forming or inducing elements may be employed to form a heating element, with the shape-forming element of a configuration corresponding to desired shape of the extruded heating element. For instance, to form a rod-shaped heating element, a ceramic powder paste may be extruded through a cylindrical die element. To form a stilt-like or rectangular-shaped heating element, a rectangular die may be employed.

After extrusion, the shaped heating element suitably may be dried e.g. in excess of 50° C. or 60° C. for a time sufficient to remove any solvent (aqueous and/or organic) carrier.

The example which follows describes preferred extrusion processes to form a heating element.

After such formation of the heating element, the element may be further treated as desired.

Thus, for example, one or more ceramic layers may be applied to a formed element such as by dip coating, spray coating and the like of a ceramic composition slurry.

As shown in an example which follows, a conductive layer may be applied to at least a portion of the exterior surface of the formed heating element. That exterior coating can function as a flame sensor in the formed heating element.

The heating element 10 then may be further processed as desired. For example, heating element 10 may be drilled or otherwise machined to modify the electrical properties of the heating element. For instance, an interior void region that serves as an insulator may be drilled within a formed heating element body.

Additionally, as discussed above, a heating element may include additional functions such as a thermocouple circuit which may operate as a flame sensor or flame rectifier.

The formed heating element 10 preferably is further densified such as under conditions that include temperature and pressure. In particular, after forming an heating element may be sintered in a single or multiple step thermal treatment.

In one multiple step protocol, a heating element formed through an extrusion and/or dip coating process may be subjected to a first thermal treatment to remove various organic and inorganic carrier materials, e.g. heating at above 1000° C. in an inert atmosphere such as argon to remove binders and the like. Thereafter, the heating element may be sintered in excess of 1600° C. for 0.5 hours or more under pressure such as under a glass-hot isostatic press.

After such densification the heating elements may be cleaned if desired and then electrical leads are affixed to the proximal end of the element to supply power to the element.

Other approaches can be employed to produce heating elements of the invention.

For instance, a heating element may be formed that is comprised of insulator ceramic composition with multiple conductive fibers or wires extending therethrough. The bulk heating element then may be sintered.

An insulator heating element body also may be produced such as through an extrusion process where a ceramic body element comprises an organic-based or inorganic-based matrix (e.g. honeycomb) that can be filled with a ceramic composition having a resistivity that differs from the resistivity of the abutting ceramic body element. For example, a honeycomb matrix can be filled with a conductive composition to define conductive pathways within the heating element, or the matrix can be filled resistive material to define a resistive zone within the heating element. Such a matrix also can be selectively filled with conductive compositions of differing temperature coefficients of resistance to provide a plurality of conductive pathways or zones of differing temperature coefficients of resistance, such one or more PTCR conductive zones and one or more NTCR zones.

Photolithography also may be employed to produce heating elements of the invention, e.g. where a photoresist is employed to define conductive pathways that can be filled with ceramic compositions as desired. Multiple conductive pathways of a heating element suitably may be fabricated in a type of build-up sequential approach, where sequential layers of conductive pathways with interposing insulator lines to provide electrical segregation are fabricated through used of imaged photoresist masks.

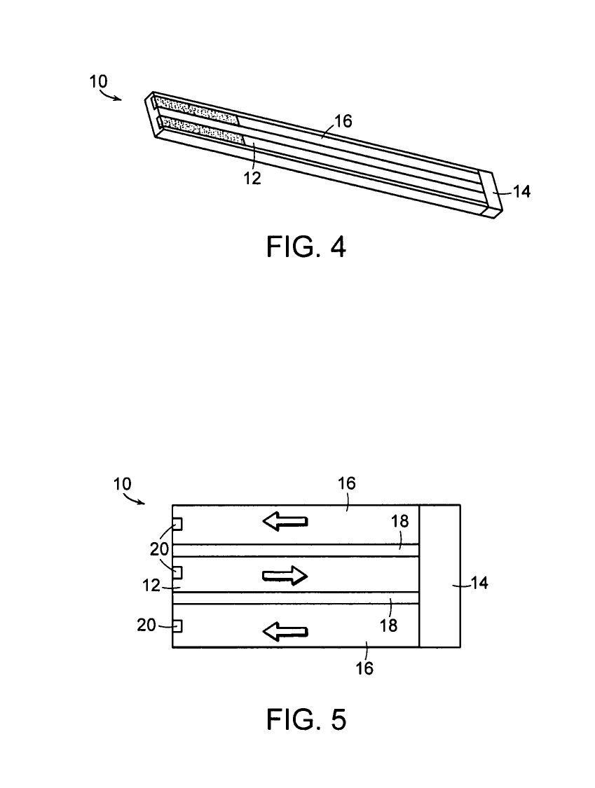

FIG. 4 shows a further preferred heating element 10 in cut-away view where region 12 comprises a plurality of electrically segregated pathways that provide power to distal resistive (ignition) zone 14 and region 16 comprises a plurality of electrically segregated pathways to complete the circuit.

FIG. 5 shows in a schematic cut-away view a preferred co-axial heating element 10 where inner region 12 comprises a plurality of electrically segregated pathways that provide power to distal resistive (ignition) zone 14 and outer region 16 comprises a plurality of electrically segregated pathways to complete the circuit. Inner region 12 and outer region 16 suitably may be separated such as by insulative region 18, which may be a void space or comprise an insulative (heat sink) ceramic material. Leads 22 can provide transmit power to the element 10.

Dimensions of heating elements of the invention may vary widely and may be selected based on intended use of the heating element. For instance, the length of a preferred heating element (length a in FIG. 2) suitably may be from about 0.5 to about 5 cm, more preferably from about 1 about 3 cm, and the heating element cross-sectional width may suitably be from about (length b in FIG. 2) suitably may be from about 0.2 to about 3 cm.

In preferred systems, the hot or resistive zone of a heating element of the invention will heat to a maximum temperature of less than about 1450° C. at nominal voltage; and a maximum temperature of less than about 1550° C. at high-end line voltages that are about 110 percent of nominal voltage; and a maximum temperature of less than about 1350° C. at low-end line voltages that are about 85 percent of nominal voltage.

A variety of compositions may be employed to form a heating element of the invention. Ceramic compositions of differing resistivies may be employed as well as hybrid systems, e.g. ceramic compositions that comprise for instance embedded metal conductive pathways. References herein to ceramic elements, ceramic conductive pathways or wires, and the like are inclusive of both such systems i.e. elements that are comprised only of ceramic materials as well as hybrid ceramic systems such as a ceramic/metal hybrid element.

In certain embodiments, if a ceramic composition is employed to form a hot zone region, generally preferred hot zone compositions comprise at least three components of 1) conductive material; 2) semiconductive material; and 3) insulating material. Conductive (cold) and insulative (heat sink) regions may be comprised of the same components, but with the components present in differing proportions. Typical conductive materials include e.g. molybdenum disilicide, tungsten disilicide, nitrides such as titanium nitride, and carbides such as titanium carbide. Typical semiconductors include carbides such as silicon carbide (doped and undoped) and boron carbide. Typical insulating materials include metal oxides such as alumina or a nitride such as AlN and/or Si₃N₄.

As referred to herein, the term electrically insulating material indicates a material having a room temperature resistivity of at least about 10¹⁰ ohms-cm. The electrically insulating material component of heating elements of the invention may be comprised solely or primarily of one or more metal nitrides and/or metal oxides, or alternatively, the insulating component may contain materials in addition to the metal oxide(s) or metal nitride(s). For instance, the insulating material component may additionally contain a nitride such as aluminum nitride (AlN), silicon nitride, or boron nitride; a rare earth oxide (e.g. yttria); or a rare earth oxynitride.

As referred to herein, a semiconductor ceramic (or “semiconductor”) is a ceramic having a room temperature resistivity of between about 10 and 10⁸ ohm-cm. If the semiconductive component is present as more than about 45 v/o of a hot zone composition (when the conductive ceramic is in the range of about 6-10 v/o), the resultant composition becomes too conductive for high voltage applications (due to lack of insulator). Conversely, if the semiconductor material is present as less than about 10 v/o (when the conductive ceramic is in the range of about 6-10 v/o), the resultant composition becomes too resistive (due to too much insulator). Again, at higher levels of conductor, more resistive mixes of the insulator and semiconductor fractions are needed to achieve the desired voltage. Typically, the semiconductor is a carbide from the group consisting of silicon carbide (doped and undoped), and boron carbide.

As referred to herein, a conductive material is one which has a room temperature resistivity of less than about 10⁻² ohm-cm. If the conductive component is present in an amount of more than 35 v/o of the hot zone composition, the resultant ceramic of the hot zone composition, the resultant ceramic can become too conductive. Typically, the conductor is selected from the group consisting of molybdenum disilicide, tungsten disilicide, and nitrides such as titanium nitride, and carbides such as titanium carbide. Molybdenum disilicide is generally preferred.

In general, preferred hot (resistive) zone compositions include (a) between about 50 and about 80 v/o of an electrically insulating material having a resistivity of at least about 10¹⁰ ohm-cm; (b) between about 5 and about 45 v/o of a semiconductive material having a resistivity of between about 10 and about 10⁸ ohm-cm; and (c) between about 5 and about 35 v/o of a metallic conductor having a resistivity of less than about 10⁻² ohm-cm. Preferably, the hot zone comprises 50-70 v/o electrically insulating ceramic, 10-45 v/o of the semiconductive ceramic, and 6-16 v/o of the conductive material.

Preferred cold zone (conductive) regions include those that are comprised of e.g. AlN and/or Al₂O₃ or other insulating material; SiC or other semiconductor material; and MoSi₂ or other conductive material. However, cold zone regions will have a significantly higher percentage of the conductive and semiconductive materials (e.g., SiC and MoSi₂) than the hot zone.

Heating elements of the present invention may be used in many applications, including gas phase fuel ignition applications such as furnaces and cooking appliances, baseboard heaters, boilers, and stove tops. In particular, a heating element of the invention may be used as an ignition source for stove top gas burners as well as gas furnaces.

Heating elements of the invention also are particularly suitable for use for ignition where liquid (wet) fuels (e.g. kerosene, gasoline) are evaporated and ignited, e.g. in vehicle (e.g. car) heaters that provide advance heating of the vehicle.

Heating elements of the invention also are suitably employed as glow plugs, e.g. as an ignition source in a motor vehicle.

Heating elements of the invention will be useful for additional specific applications, including as a heating element fro an infrared heater.

The following non-limiting example is illustrative of the invention. All documents mentioned herein are incorporated herein by reference in their entirety.

### EXAMPLE 1

### Heating Element Fabrication

A heating element of the invention of the general configuration shown in FIG. 2 of the drawings may be prepared as follows.

Powders of a conductive composition (30 vol % MoSi₂, 20 vol % SiC, remainder Al₂O₃) and an insulating composition (20 vol % SiC and 80 vol % Al₂O₃) were separately mixed with about 16 wt % water and 5 wt % Methyl Cellulose (Dow A4M) to form two pastes. The two pastes are formed into rod shapes with the insulating paste forming about 40 rods elements and the resistive paste forming about 5 elements that are segregated by the insulating rods. Those packed rods are then extruded and reduced through a 0.31 inch diameter die on a Mohr piston extruder to provide a cylindrical heating element.

After that replication process, the conductive rods are reduced to about 0.05 inches in diameter and two of the conductive rods can form a circuit with a conductive cap affixed to the distal end of the heating element.

The heating element is then dip coated to coat at least a portion of the exterior heating element length with a slurry of conducting composition (30 vol % MoSi₂, 20 vol % SiC, remainder Al₂O₃). The slurry suitably contains dispersants and a low viscosity base fluid containing isopropyl alcohol, PEG 400 (emulsifier; reaction product of stearic acid), SANTICIZER 160 (plasticizer; butyl benzyl), BUTWAR B76 (Monsanto; polyvinyl butyral), 111M dispersant (DARVAN). The exterior coating can function as a flame sensor in the formed heating element.

The thus coated heating element is pre-sintered in Argon atmosphere at 1200° C. to burn out the binders, coated with boron nitride and densified at 1750° C. for 1 hour under a glass-hot isostatic press. The densified parts are cleaned by grit-blasting and an electrical leads are affixed to the proximal end of the element to supply power to the element.

### EXAMPLE 2

### Co-Axial Heating Element

A heating element of corresponding to the configuration of FIG. 5 of the drawings is prepared by the general procedures of Example 1 above.

The invention has been described in detail with reference to particular embodiments thereof. However, it will be appreciated that those skilled in the art, upon consideration of this disclosure, may make modification and improvements within the spirit and scope of the invention.

1. A resistive ceramic heating element comprising at least three electrically segregated conductive zones.

2. A resistive ceramic heating element comprising a plurality of conductive zones, wherein only a portion of the conductive zones pass current during use of the heating element.

3. A resistive ceramic heating element comprising a plurality of conductive zones, wherein two or more of the conductive pathways have differing temperature coefficients of resistance.

4. A heating element of claim 3 wherein one or more of the conductive zones has a PTCR and one or more of the conductive zones has a NTCR.

5. A heating element of claim 1, wherein the heating element comprises at least ten electrically segregated conductive zones.

6. A heating element of claim 1, wherein the heating element comprises at least one hundred electrically segregated conductive zones.

7. A heating element of claim 1, wherein the heating element comprises at least one thousand electrically segregated conductive zones.

8. A heating element of claim 1, wherein the heating element comprises one or more conductive zones having a cross-section dimension of about 500 microns or less.

9. A heating element of claim 1, wherein up to about 70 percent of the total number pass current during use of the heating element

10. A heating element of claim 1, wherein one or more insulator zones are interposed between the conductive zones.

11. A heating element of claim 1, wherein the heating element comprises a conductive cap element.

12. A heating element of claim 1, wherein the heating element has a substantially circular cross-sectional shape.

13. A heating element of claim 1, wherein the heating element has a co-axial design.

14. A method of igniting fuel, comprising applying an electric current across a heating element of claim 1.

15. A method of claim 14 wherein the current has a nominal voltage of 6, 8, 10, 12, 24, 120, 220, 230 or 240 volts.

16. A glow plug comprising a heating element of claim 1.

17. A heating apparatus comprising a heating element of claim 1.

18. A method for providing power to a heating element, comprising:
providing a resistive ceramic heating element comprising at least three electrically segregated conductive zones; and
engaging one or more electrical connections with respect to the heating element to provide power to one or more selected conductive zones.

19. The method of claim 18 wherein the one or more electrical connections are engaged to a selected number of conductive zones whereby the igniter operates at a targeted voltage.

20. The method of claim 18 wherein the one or more electrical connections are shifted during operational lifetime of the heating element to provide power to one or more alternate conductive zones.
